(19) United States
(12) Patent Application Publication
(10) Pub. No.: US 2009/0260991 A1
(43) Pub. Date: Oct. 22, 2009

(54) METHODS FOR PRODUCING METAL OXIDE THIN FILM, CAPACITOR, HYDROGEN SEPARATION MEMBRANE-ELECTROLYTE MEMBRANE ASSEMBLY, AND FUEL CELL

(75) Inventors: Naoki Ito, Kanagawa-ken (JP); Yasuyuki Matsumura, Osaka (JP); Kazuya Matsui, Osaka (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi ,Aichi-ken (JP)

(21) Appl. No.: 12/439,929

(22) PCT Filed: Mar. 19, 2008
(86) PCT No.: PCT/IB2008/000652

§ 371 Date: Mar. 4, 2009

(30) Foreign Application Priority Data
Mar. 20, 2007 (JP) 2007-073707

(51) Int. Cl. H01M 4/04

(52) U.S. Cl. 205/58

(57) ABSTRACT

A method for producing a metal oxide thin film (70) includes a plating process in which a methyl-ketone-based organic solution (20) containing dimethyl sulfoxide and halogen is used as a plating solution. Using such an organic solution, which is corrosive, as the plating solution, a thin film of non-water-soluble metal oxides can be formed. Further, owing to the halogen and dimethyl sulfoxide contained in the organic solution, the formed metal oxide thin film has a high thickness uniformity and a high density.

### BACKGROUND OF THE INVENTION

1. Field of the Invention

The invention relates to methods for producing a metal oxide thin film, a capacitor, a hydrogen separation membrane-electrolyte membrane assembly, and a fuel cell.

2. Description of the Related Art

As metal oxide thin film producing methods, there are known: methods in which a metal oxide precursor solution is applied to a substrate using a dip-coating method or a spin-coating method and then it is heated, whereby an oxide thin film is formed; and methods in which a metal oxide precursor solution is applied to a substrate using a chemical-vapor-deposition method and then it is heated, whereby an oxide thin film is formed. Although these methods are relatively simple, very strict conditions need to be satisfied to form a thin film having a sufficiently high thickness uniformity. From this viewpoint, these thin-film-forming methods are not always easy. Also known is a method in which a thin film is formed on a substrate by sputtering metal oxides onto the substrate. This method, however, requires a large-scale equipment.

Other than the methods described above, in recent years, technologies for forming a metal oxide thin film on a substrate by plating have been developed. When a metal oxide thin film is formed by plating, the equipment cost is low and the forming process is simple. Therefore, such a plating-based forming method can be easily put into practical use. In typical metal oxide plating methods, a solution containing metal ions is used as a plating solution. For example, Japanese Patent Application Publication No. 2002-194556 (JP-A-2002-194556) discloses a method in which a water solution containing Pb (lead) ions, Zr (zirconium) ions, Ti (titanium) ions, La (lanthanum) ions, or nitric acid ions, and a reducing agent is used as a plating solution.

According to this technology, the reducing agent reduces nitric acid ions into nitrous acid ions on the surface of the substrate. At this time, due to the hydroxyl groups produced on the surface of the substrate, metal ions accumulates on the surface of the substrate as hydroxides or oxides. On the other hand, another method is known in which hydroxyl groups are produced on a conductive substrate by voltage application instead of using the reducing agent, and metal hydroxides or metal oxides are plated to the surface of the substrate.

According to the technology described in JP-A-2002-194556, however, when forming a highly dielectric tantalum oxide thin film or a highly dielectric niobium oxide thin film, which are often used in capacitors, a water-based plating solution can not be used because tantalum ions and niobium ions are not water-soluble.

In view of the above, there is known a technology in which an anode made of metallic tantalum, metallic niobium, or the like, and a cathode as a conductive plated object are put in a corrosive organic solution and voltage is applied to the anode and the cathode so that the anode is corrosively dissolved, and metal ions produced as a result of the corrosive dissolution of the anode and hydroxyl groups or oxygen ions produced on the cathode react with each other, whereby oxide plating is performed.

For example, as a corrosive organic solvent, those obtained by adding bromine or iodine to acetone are known (Refer to Page 321-327 of Volume 49 of “Anodic Dissolution of tantalum and niobium in acetone solvent with halogen additives for electrochemical synthesis of Ta₂O₅ and Nb₂O₅ thin films” by Kai Kamada, Maki Mukai and Yasumichi Matsumoto, Elecrochimica Acta). In this method, voltage of 50 V is applied between the anode and the cathode.

The present inventors formed a tantalum oxide thin film using a palladium plate as a plated object according to this method, however the thickness of the formed thin film was not uniform due to hydrogen produced from the anode, etc.

### SUMMARY OF THE INVENTION

The invention provides a method for producing a metal oxide thin film having a high thickness uniformity and a high density using an organic solvent as a plating solution.

The first aspect of the invention relates to a method for producing a metal oxide thin film, including a plating process in which a methyl-ketone-based organic solution containing dimethyl sulfoxide and halogen is used as a plating solution. According to this method, owing to the halogen and dimethyl sulfoxide contained in the organic solution, the formed metal oxide thin film has a high thickness uniformity and a high density, and further, the use of the organic solution, which is corrosive, enables to form a thin film of non-water-soluble metal oxides.

The method described above may further include a heating process in which a metal oxide thin film or a metal hydroxide thin film created by the plating process is heated. In this case, even if the thin film created by the plating process is amorphous, a crystalloid metal oxide thin film can be formed.

Further, in the method described above, the methyl-ketone-based organic solution may contain proton-donating organic matter. In this case, the conductivity of the methyl-ketone-organic solution increases, whereby the thin film is formed more quickly. Further, in the method described above, the proton-donating organic matter may include at lease one of methanol, ethanol, propanol, and acetic acid, and the halogen may be bromine.

The second aspect of the invention relates to a method for producing a capacitor, including: a preparing process for preparing a first electrode; a dielectric-portion forming process in which a dielectric portion constituted of a metal oxide thin film is formed on the first electrode using the method according to the first aspect of the invention; and an electrode forming process in which a second electrode is formed on the dielectric portion. According to this method, it is possible to produce a capacitor having a dielectric portion having a high thickness uniformity and a high density.

The third aspect of the invention relates to a method for producing a hydrogen separation membrane-electrolyte membrane assembly, including: a preparing process for preparing a hydrogen separation membrane having a hydrogen permeability; and an electrolyte-membrane forming process in which a proton-conductive electrolyte membrane constituted of a metal oxide thin film is formed on the hydrogen separation membrane using the method according to the first aspect of the invention. According to this method, it is possible to produce a hydrogen separation membrane-electrolyte membrane assembly with an electrolyte membrane having a high thickness uniformity and a high density.

The forth aspect of the invention relates to a method for producing a fuel cell, including a cathode forming process in which a cathode is formed on the proton-conductive electrolyte membrane of the hydrogen separation membrane-electrolyte membrane assembly produced using the method according to the third aspect of the invention. According to this method, it is possible to produce a fuel cell with an electrolyte membrane having a high thickness uniformity and a high density.

According to the invention, as such, a metal oxide thin film having a high thickness uniformity and a high density can be produced using an organic solution as a plating solution.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1A and FIG. 1B are views illustrating the flow of a metal oxide thin film producing method according to the first example embodiment of the invention;

FIG. 2 is a view illustrating other metal oxide thin film producing method;

FIG. 3A, FIG. 3B and FIG. 3C are views illustrating the flow of a capacitor producing method according to the second example embodiment of the invention; and

FIG. 4A, FIG. 4B, and FIG. 4C are views illustrating the flow of a fuel cell producing method according to the third example embodiment of the invention.

### DETAILED DESCRIPTION OF THE EMBODIMENTS

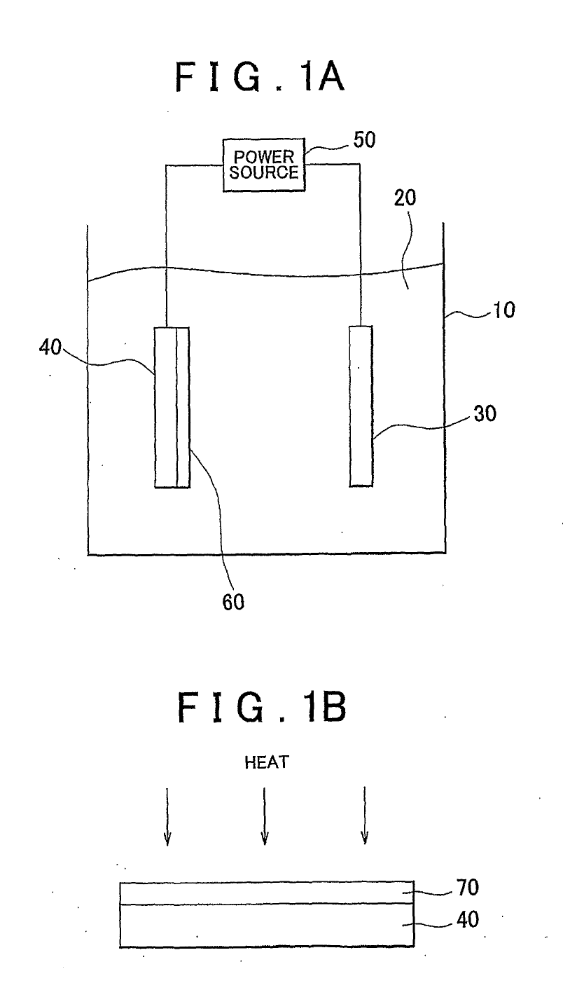

FIG. 1A and FIG. 1B are views illustrating the flow of a metal oxide thin film producing method according to the first example embodiment of the invention. First, referring to FIG. 1A, an anode 30 made of a given metal and a cathode 40 used as a thin-film substrate and having a conductivity are soaked in a methyl-ketone-based organic solution 20 in a container 10. In this example embodiment, the methyl-ketone-based organic solution 20 contains dimethyl sulfoxide and halogen. The anode 30 and the cathode 40 are connected to a power source 50. When the power source 50 is turned on, oxides or hydroxides of the metal constituting the anode 30 are plated onto the cathode 40, whereby a thin film 60 having an uniform thickness and a high density is formed. It is to be noted that the methyl-ketone-based organic solution 20 may either be kept still or agitated at the time of voltage application. Further, the plating may be selectively performed to a specific portion or portions of the cathode 40 by means of masking, or the like.

The thin film 60 formed through the foregoing plating is amorphous. The thin film 60 may be put into practical use as it is. In the case where the thin film 60 needs to be formed as a crystalloid metal oxide thin film, it can be obtained by heating the thin film 60 as illustrated in FIG. 1B. By doing so, a crystalloid metal oxide thin film 70 can be formed. In this case, the heating temperature and the heating time are set in consideration of the heat resistances of the cathode 40 and the thin film 60, the crystal growth characteristic, and so on.

Methyl-ketone used for the methyl-ketone-based organic solution 20 may be selected from among those having a structure of CH₃COR (“R” represents a hydrocarbon group of C7 or lower). This is because if the methyl-ketone-based organic solution 20 is of methyl-ketone constituted of a hydrocarbon group (R) of C8 or higher, the viscosity of the solution is high, the ion-diffusibility of the solution is low, and thus the plating efficiency is low. The followings are examples of methyl-ketone that can be used for the methyl-ketone-based organic solution 20; acetone, methyl ethyl ketone, methyl n-propyl ketone, methyl isopropyl ketone, 2-pentanon, methyl isobutyl ketone, methyl t-butyl ketone, 2-hexanon, 3-methyl-2-pentanon, 4-methyl-2-pentanon, 2-heptanone, acetophenone, and mixtures of these substances.

The halogen contained in the methyl-ketone may either be bromine or iodine, or more particularly may be bromine.

The concentration of halogen in the methyl-ketone-based organic solution 20 is not limited to any specific value. For example, it may be set, as halogen molecules, to 0.002 to 0.1 mol/L, or more particularly to 0.005 to 0.05 mol/L. If the halogen concentration is lower than 0.002 mol/L, the corrosiveness of the solution is not high enough to corrosively dissolve the anode sufficiently, and if the halogen concentration is higher than 0.05 mol/L, the solution oxidizes the anode excessively.

Halogen and methyl ketone cause haloform reactions, whereby RCOCH₂X (“X” represents halogen) and HX are produced. In this case, the conductivity and the corrosiveness of the methyl-ketone-based organic solution 20 improve.

The concentration of dimethyl sulfoxide in the methyl-ketone-based organic solution 20 is not limited to any specific value. For example, it is set to 0.005 to 0.5 mol/L, and more particularly to 0.01 to 0.3 mol/L.

Through interactions with the coexisting halogen, the dimethyl sulfoxide improves the corrosiveness of the methyl-ketone-based organic solution 20 and makes the thin film 60 uniform.

The methyl-ketone-based organic solution 20 may further contain organic matter having a proton-donating property. In this case, the conductivity of the methyl-ketone-base solution further improves, and the thin film 60 is formed more quickly. Examples of this proton-donating organic matter include; methanol, ethanol, n-propanol, isopropanol, acetic acid, propionic acid, and mixtures of these substances.

The concentration of the proton-donating organic matter in the methyl-ketone-based organic solution 20 is not limited to any specific value. For example, it may be set to 5 mol/L or lower, and more particularly to 2 mol/L or lower. This is because if the concentration of the proton donating organic matter is higher than 5 mol/L, hydrogen is produced during the plating, which deteriorates the thickness uniformity of the plating coat.

The metal of which the anode 30 is made is not limited to any specific metal. For example, it may be selected from among: magnesium, aluminum, titanium, zirconium, vanadium, niobium, tantalum, chrome, molybdenum, and tungsten. These metals have a low reducibility and thus are suitable for plating by an organic solution. The shape of the anode 30 is not limited to any specific shape, and it may be formed in, for example, a plate-like shape, a bar-like shape, a cylindrical shape, a net-like shape, and so on. The shape of the anode 30 may be selected so as to match the shape of the cathode 40. The cathode 40 may be made of any material as long as it is conductive.

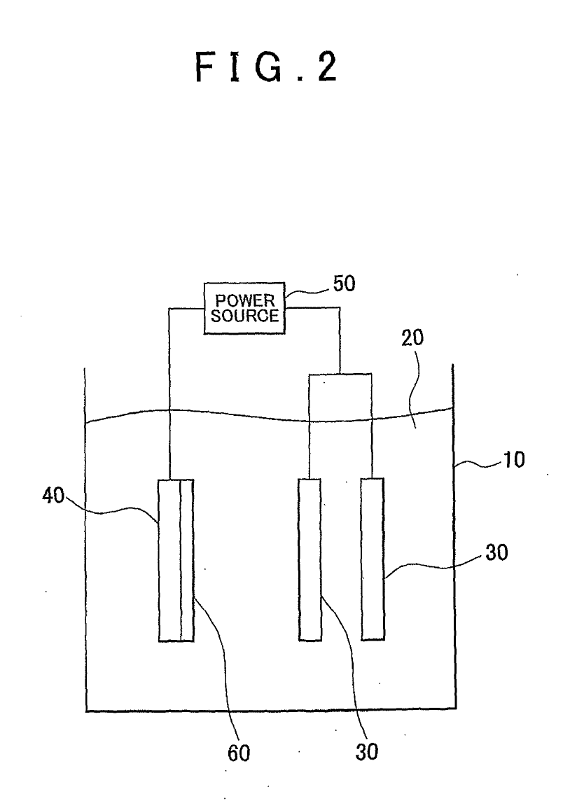

The voltage applied from the power source 50 is not limited to any specific value as long as it is appropriate to dissolve the anode 30 and form the thin film 60 on the cathode 40. For example, it may be set within the range of 30 to 250 V, and more particularly within the range of 50 to 200 V Further, as in the example illustrated in FIG. 2, two or more anodes may be used at one time such that each cathode and anode are energized at different voltages. In this case, the thin film 60 is formed of compound metal oxides on the cathode 40. If the voltage is lower than 30 V, the rate of corrosive dissolution of the anode is too low, and if the voltage is higher than 250 V, on the other hand, undesired side reactions occur.

The temperature of the methyl-ketone-based organic solution 20 at the time of voltage application from the power source 50 is not limited to any specific value as long as the methyl-ketone-based organic solution 20 is not boiled. For example, it may be set within the range of 0 to 70° C., and more particularly within the range of 15 to 50° C. If the temperature of the methyl-ketone-based organic solution 20 is lower than 0° C., the ion-solubility of the methyl-ketone-based organic solution 20 is too low, and on the other hand, if the temperature of the methyl-ketone-based organic solution 20 is higher than 70° C., the solution evaporates and thus the plating condition varies significantly.

According to the metal oxide thin film producing method of this example embodiment, as described above, because a corrosive organic solvent is used as the plating solution, a non-water-soluble metal oxide thin film can be formed. Further, because halogen and dimethyl sulfoxide are contained in the organic solvent, the formed metal oxide thin film has a high thickness uniformity and a high density.

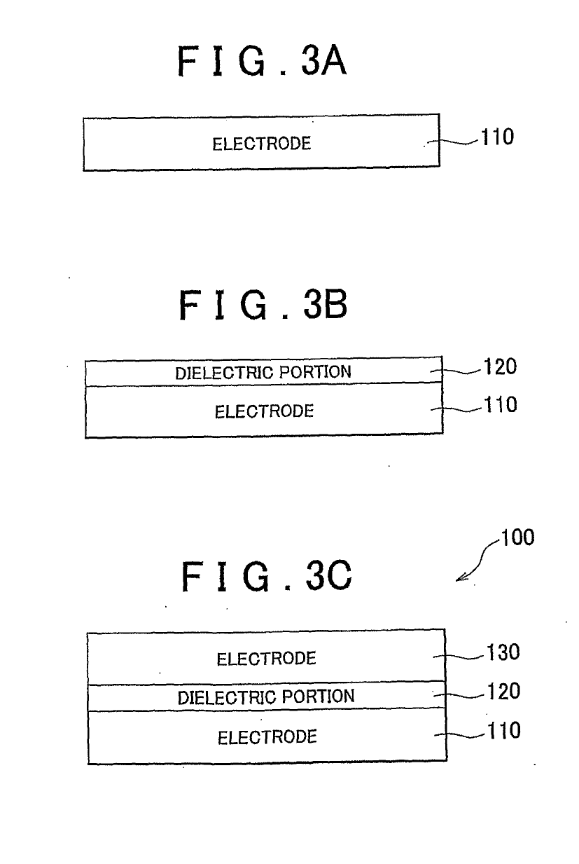

Next, the second example embodiment of the invention will be described which relates to a method for producing a capacitor 100. FIG. 3A to FIG. 3C illustrate the flow of a method for producing the capacitor 100. First, an electrode 110 is prepared as shown in FIG. 3A. The electrode 110 may be made of any material as long as it is conductive. Next, a dielectric portion 120 is formed on one side of the electrode 110 as shown in FIG. 3B. At this time, the dielectric portion 120 is formed according to the metal oxide thin film producing method of the first example embodiment. In the second example embodiment, the anode is made of metal that can be used as a dielectric when oxidized, such as niobium and tantalum.

Subsequently, an electrode 130 is formed on the dielectric portion 120 by the sputtering method, or the like, as shown in FIG. 3C, so that the capacitor 100 is completed. The electrode 130 may be made of any material as long as it is conductive. According to the capacitor producing method of the second example embodiment, as described above, a capacitor with a dielectric portion formed of a non-water-soluble metal oxide thin film having a high thickness uniformity and a high density can be produced. It is to be noted that in the second example embodiment the electrode 110 and the electrode 130 may be regarded as corresponding to “first electrode” and “second electrode”, respectively.

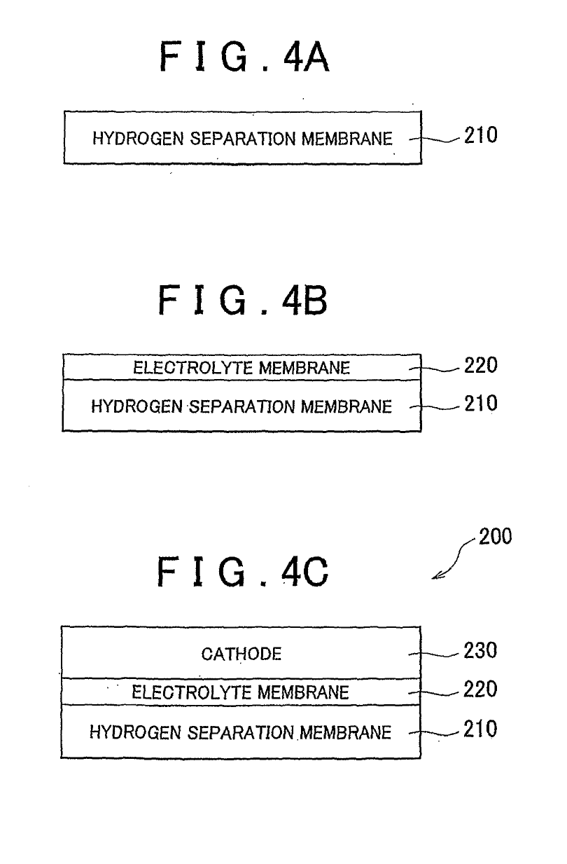

Next, the third example embodiment of the invention will be described which relates to a method for producing a fuel cell 200. FIG. 4A to FIG. 4C illustrate the flow of a method for producing the fuel cell 200. First, a hydrogen separation membrane 210 is prepared as shown in FIG. 4A. The hydrogen separation membrane 210 may be made of any material as long as it has hydrogen permeability and electrical conductivity. For example, the hydrogen separation membrane 210 may be made of palladium, niobium, vanadium, tantalum, titanium, and alloys of these metals.

Subsequently, an electrolyte membrane 220 having a proton conductivity is formed on one side of the hydrogen separation membrane 210, whereby a hydrogen separation membrane-electrolyte membrane assembly is completed. At this time, the electrolyte membrane 220 is formed according to the metal oxide thin film producing method of the first example embodiment. In the third example embodiment, the anode is made of metal that can be used as a proton-conductive electrolyte when oxidized, such as niobium and tantalum.

Next, a cathode 230 is formed on the electrolyte membrane 220 as shown in FIG. 4C, whereby the fuel cell 200 is completed. The cathode 230 is made of a conductive material such as lanthanum cobaltite, lanthanum manganate, silver, platinum, platinum-carrying carbon, etc. The cathode 230 may be formed using the screen-printing method, or the like.

In the following, the outline of the operation of the fuel cell 200 will be described. First, hydrogen-containing fuel gas is supplied to the hydrogen separation membrane 210. The hydrogen contained in the fuel gas passes through the hydrogen separation membrane 210 and then is converted to protons at the interface between the hydrogen separation membrane 210 and the electrolyte membrane 220. These protons travel through the electrolyte membrane 220 and reach the cathode 230. On the other hand, oxygen-containing oxidizing gas is supplied to the cathode 230. At the cathode 230, the oxygen in the oxidizing gas and the protons, which have reached the cathode 230, react with each other, whereby water is produced and electric power is generated. As such, the fuel cell 200 supplies electric power to respective loads.

According to the fuel cell producing method of the third example embodiment of the invention, as described above, it is possible to form a hydrogen separation membrane-electrolyte membrane assembly constituted of an electrolyte membrane having a high thickness uniformity and a high density, which is a non-water-soluble metal oxide thin film, and thus produce fuel cells each constituted of such a hydrogen separation membrane-electrolyte membrane assembly. Further, according to the fuel cell producing method of the third example embodiment, the thickness of the electrolyte membrane 220 is reduced, and therefore the power generation resistance of the fuel cell 200 is reduced accordingly.

Metal oxide thin films were formed according to the methods of the respective example embodiments described above, and the thickness uniformity and the density of each of the formed metal oxide thin films were examined. Table I shows the conditions for forming the respective metal oxide thin films.

TABLE 1

| | | | | | | Proton | |
|---|---|---|---|---|---|---|---|
| | | | Methyl Ketone | Dimethyl | | donating | |
| | Anode | Cathode | Solution | sulfoxide | Halogen | agent | Voltage |
| Example 1 | Nb | Pd | 2-pentanone | 0.03 mol/l | Br | Not | 150 V |
| | | | | | 0.01 mol/l | contained | |
| Example 2 | Nb | Pd | 2-pentanone | 0.03 mol/l | Br | Methanol | 150 V |
| | | | | | 0.01 mol/l | 0.4 mol/l | |
| Example 3 | Nb | Pd | 2-pentanone | 0.03 mol/l | Br | Ethanol | 150 V |
| | | | | | 0.01 mol/l | 0.4 mol/l | |
| Example 4 | Nb | Pd | 2-pentanone | 0.03 mol/l | Br | 1-propanol | 150 V |
| | | | | | 0.01 mol/l | 0.4 mol/l | |
| Example 5 | Nb | Pd | 2-pentanone | 0.03 mol/l | Br | Acetic acid | 150 V |
| | | | | | 0.01 mol/l | 0.4 mol/l | |
| Example 6 | Nb | Pd | 2-pentanone | 0.03 mol/l | Br | Ethanol | 150 V |
| | | | | | 0.01 mol/l | 0.8 mol/l | |
| Example 7 | Nb | Pd | 2-pentanone | 0.3 mol/l | Br | Ethanol | 150 V |
| | | | | | 0.01 mol/l | 0.4 mol/l | |
| Example 8 | Nb | Pd | 2-pentanone | 0.03 mol/l | Br | Ethanol | 50 V |
| | | | | | 0.01 mol/l | 0.4 mol/l | |
| Example 9 | Ti | Pd | 2-pentanone | 0.03 mol/l | Br | Ethanol | 150 V |
| | | | | | 0.01 mol/l | 0.4 mol/l | |
| Example 10 | Ta | Pd | 2-pentanone | 0.03 mol/l | Br | Ethanol | 150 V |
| | | | | | 0.01 mol/l | 0.4 mol/l | |
| Example 11 | Nb, Mg | Pd | 2-pentanone | 0.03 mol/l | Br | Ethanol | 150 V, 100 V |
| | | | | | 0.01 mol/l | 0.4 mol/l | |
| Example 12 | Nb | Pd | Mixture of | 0.03 mol/l | Br | Acetic acid | 150 V |
| | | | 2-pentanone | | 0.01 mol/l | 0.4 mol/l | |
| | | | and acetone | | | | |
| Example 13 | Nb | Pd | 2-pentanone | 0.03 mol/l | Br | Ethanol | 150 V |
| | | | | | 0.05 mol/l | 0.4 mol/l | |
| Example 14 | Ta | Pd | 2-pentanone | 0.08 mol/l | Br | Not | 50 V |
| | | | | | 0.01 mol/l | contained | |
| Comparative | Nb | Pd | 2-pentanone | Not | Br | Not | 150 V |
| Example 1 | | | | contained | 0.01 mol/l | contained | |
| Comparative | Nb | Pd | 2-pentanone | Not | Br | Ethanol | 150 V |
| Example 2 | | | | contained | 0.01 mol/l | 0.4 mol/l | |

In the example 1, the metal oxide thin film 70 is formed according to the method of the first example embodiment described above. A niobium plate having a thickness of 0.2 mm was used as the anode 30, and a palladium plate having a thickness of 0.1 mm was used as the cathode 40. A 2-pentanone solution having a bromine concentration of 0.01 mol/L and a dimethyl sulfoxide concentration of 0.03 mol/L was used as the methyl-ketone-based organic solution 20.

The anode 30 and the cathode 40 were soaked in the methyl-ketone-based organic solution 20. The anode 30 and the cathode 40 were arranged in parallel at an interval of 5 mm. DC voltage of 150 V was applied between the anode 30 and the cathode 40 for 30 minutes, whereby the thin film 60 was formed on the cathode 40. Next, the thin film 60 was heated at 700° C. for 3 hours, whereby a niobium oxide thin film was formed as the metal oxide thin film 70.

In the example 2, methanol was added to the methyl-ketone-based organic solution 20 such that the methanol concentration in the methyl-ketone-based organic solution 20 was 0.4 mol/L. Other conditions were the same as those of the example 1 described above.

In the example 3, ethanol was added to the methyl-ketone-based organic solution 20 such that the ethanol concentration in the methyl-ketone-based organic solution 20 was 0.4 mol/L. Other conditions were the same as those of the example 1 described above.

In the example 4, 1-pronopal was added to the methyl-ketone-based organic solution 20 such that the 1-pronopal concentration in the methyl-ketone-based organic solution 20 was 0.4 mol/L. Other conditions were the same as those of the example 1 described above.

In the example 5, acetic acid was added to the methyl-ketone-based organic solution 20 such that the acetic acid concentration in the methyl-ketone-based organic solution 20 was 0.4 mol/L. Other conditions were the same as those of the example 1 described above.

In the example 6, ethanol was added to the methyl-ketone-based organic solution 20 such that the ethanol concentration in the methyl-ketone-based organic solution 20 was 0.8 mol/L. Other conditions were the same as those of the example 1 described above.

In the example 7, the dimethyl sulfoxide concentration in the methyl-ketone-based organic solution 20 was 0.3 mol/L. Other conditions were the same as those of the example 3 described above.

In the example 8, voltage of 30 V was applied between the anode 30 and the cathode 40. Other conditions were the same as those of the example 3 described above.

In the example 9, a titanium plate having a thickness of 0.2 mm was used as the anode 30, and the thin film 60 was heated at 700° C. for 3 hours, whereby a titanium oxide thin film was formed as the metal oxide thin film 70. Other conditions were the same as those of the example 3 described above.

In the example 10, a tantalum plate having a thickness of 0.2 mm was used as the anode 30, and the thin film 60 was heated at 700° C. for 3 hours, whereby a tantalum oxide thin film was formed as the metal oxide thin film 70. Other conditions were the same as those of the example 3 described above.

In the example 11, a niobium plate having a thickness of 0.2 mm and a magnesium rod having a diameter of 1 mm were used as the anode 30, and a palladium plate having a thickness of 0.1 mm was used as the cathode 40. A 2-pentanone solution having a bromine concentration of 0.01 mol/L, a dimethyl sulfoxide concentration of 0.03 mol/L, and an ethanol concentration of 0.4 mol/L was used as the methyl-ketone-based organic solution 20.

The cathode 40 and the magnesium rod were arranged in parallel at an interval of 10 mm, and the niobium plate was arranged between the cathode 40 and the magnesium rod so as to be parallel to the cathode 40 at an interval of 5 mm. DC voltage of 150 V was applied between the cathode 40 and the niobium plate for 30 minutes, and DC voltage of 100 V was applied between the cathode 40 and the magnesium rod for 30 minutes, whereby the thin film 60 was formed. The thin film 60 was heated at 700° C. for 3 hours, whereby a compound thin film constituted of niobium oxides and magnesium oxides was formed as the metal oxide thin film 70.

In the example 12, a mixture of 2-pentanone and acetone (30% of acetone) was used instead of 2-pentaone. Other conditions were the same as those of the example 5 described above.

In the example 13, the bromine concentration was 0.05 mol/L. Other conditions were the same as those of the example 3 described above.

In the example 14, the dimethyl sulfoxide concentration in the methyl-ketone-based organic solution 20 was 0.08 mol/L and no proton-donating agent was added, and voltage of 50 V was applied between the anode 30 and the cathode 40. Other conditions were the same as those of the example 10 described above.

In the comparative example 1, no dimethyl sulfoxide was contained in the methyl-ketone-based organic solution 20. Other conditions were the same as those of the example 1 described above.

In the comparative example 2, no dimethyl sulfoxide was contained in the methyl-ketone-based organic solution 20. Other conditions were the same as those of the example 3 described above.

The thickness uniformities and densities of the metal oxide thin films of the examples 1 to 12 and the comparative examples 1 and 2 were examined. Table 2 shows the result of the examination. The thickness uniformities and densities were rated in three levels. Regarding the thickness uniformity, “NG” was given if any portion of the cathode was exposed, “Good” was given if no portion of the cathode was exposed but the thickness was not uniform, and “Excellent” was given if no portion of the cathode was exposed and the thickness was uniform. Regarding the density, “NG” was given if noticeable pores were found in the surface, “Good” was given if no noticeable pores were found in the surface but noticeable irregularities were found on the surface, and “Excellent” was given if no noticeable pores and no irregularities were found.

| | Uniformity | Density |
|---|---|---|
| Example 1 | Good | Good |
| Example 2 | Good | Good |
| Example 3 | Good | Excellent |
| Example 4 | Excellent | Good |
| Example 5 | Excellent | Excellent |
| Example 6 | Good | Good |
| Example 7 | Good | Good |
| Example 8 | Good | Good |
| Example 9 | Excellent | Good |
| Example 10 | Good | Excellent |
| Example 11 | Good | Good |
| Example 12 | Excellent | Excellent |
| Example 13 | Good | Good |
| Example 14 | Excellent | Good |
| Comparative Example 1 | NG | NG |
| Comparative Example 1 | NG | Good |

As shown in FIG. 2, the comparative example 1 was rated as “NG” for both the thickness uniformity and the density, and the comparative example 2 was rated as “NG” for the thickness uniformity although it was rated as “Good” for the density. These results are caused by hydrogen produced at the cathode.

On the other hand, the example 1 was rated as “Good” for both the thickness uniformity and the density owing to the halogen and dimethyl sulfoxide added to the methyl-ketone-based organic solution 20. The examples 3, 4, 5, 9, 10, and 12 were rated as “Excellent” for at least one of the thickness uniformity and the density owing to the conductivity of the methyl-ketone-based organic solution 20 increased by the proton-donating organic matter added to the methyl-ketone-based organic solution 20.

Thus, the above examination results demonstrate that a metal oxide thin film having a higher thickness uniformity and a higher density can be produced if halogen and dimethyl sulfoxide are added to the methyl-ketone-based organic solution 20 and that the thickness uniformity and density of the metal oxide thin film can be further improved by adding proton-donating organic matter to the methyl-ketone-based organic solution 20.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A method for producing a metal oxide thin film, comprising:
a plating process in which a methyl-ketone-based organic solution containing dimethyl sulfoxide and halogen is used as a plating solution.

2. The method according to claim 1, further comprising:
a heating process in which a metal oxide thin film or a metal hydroxide thin film created by the plating process is heated.

3. The method according to claim 1, wherein the methyl-ketone-based organic solution contains proton-donating organic matter.

4. The method according to claim 3, wherein the concentration of the proton-donating organic matter in the methyl-ketone-based organic solution is 5 mol/L or lower.

5. The method according to claim 3, wherein the proton-donating organic matter includes at least one of methanol, ethanol, propanol, and acetic acid.

6. The method according to claim 1, wherein the concentration of the halogen in the methyl-ketone-based organic solution is, as halogen molecules, 0.002 to 0.1 mol/L.

7. The method according to claim 1, wherein the halogen is bromine.

8. A method for producing a capacitor, comprising:
a preparing process for preparing a first electrode;
a dielectric-portion forming process in which a dielectric portion constituted of a metal oxide thin film is formed on the first electrode using the method according to claim 1; and
an electrode forming process in which a second electrode is formed on the dielectric portion.

9. A method for producing a hydrogen separation membrane-electrolyte membrane assembly, comprising:
a preparing process for preparing a hydrogen separation membrane having a hydrogen permeability; and
an electrolyte-membrane forming process in which a proton-conductive electrolyte membrane constituted of a metal oxide thin film is formed on the hydrogen separation membrane using the method according to claim 1.

10. A method for producing a fuel cell, comprising:
a cathode forming process in which a cathode is formed on the proton-conductive electrolyte membrane of the hydrogen separation membrane-electrolyte membrane assembly produced using the method according to claim 9.
